(19) United States
(12) Patent Application Publication
(10) Pub. No.: US 2012/0187283 A1
(43) Pub. Date: Jul. 26, 2012

(54) LASER RADAR SYSTEM AND LIGHT RECEIVING DEVICE

(75) Inventors: Masato Yamada, Inuyama-City (JP); Yoshiaki Maeno, Mizuho-Shi (JP)

(73) Assignee: Sanyo Electric Co., Ltd., Moriguchi-shi (JP)

(21) Appl. No.: 13/358,649

(22) Filed: Jan. 26, 2012

(30) Foreign Application Priority Data
Jan. 26, 2011 (JP) 2011-014339

(51) Int. Cl. H01J 40/14

(52) U.S. Cl. 250/234

(57) ABSTRACT

A laser radar system is provided with a laser light source which emits laser light, a light scanning portion which causes the laser light to scan a target area, an optical filter which removes light of an angle component different from an angle component of reflected light of the laser light from the target area, a photodetector which receives the reflected light transmitted through the optical filter, and a light collecting element which collects the reflected light on the photodetector.

This application claims priority under 35 U.S.C. Section 119 of Japanese Patent Application No. 2011-014339 filed Jan. 26, 2011, entitled “LASER RADAR SYSTEM AND LIGHT RECEIVING DEVICE”. The disclosure of the above application is incorporated herein by reference.

### BACKGROUND OF THE INVENTION

1. Field of the Invention

The present invention relates to a laser radar system for detecting a status of a target area based on reflected light from the target area irradiated with laser light, and a light receiving device loaded with the laser radar system.

2. Disclosure of Related Art

In recent years, a laser radar system has been loaded in a family automobile or a like vehicle to enhance security in driving. Further, the laser radar system has also been used as security measures such as detecting intrusion into a building. Generally, the laser radar system is so configured as to scan a target area with laser light to detect presence or absence of an obstacle at each of scanning positions, based on presence or absence of reflected light at each of the scanning positions. The laser radar system is also configured to detect a distance to the obstacle at each of the scanning positions, based on a required time from an irradiation timing of laser light to a light receiving timing of reflected light at each of the scanning positions.

As an arrangement of the laser radar system, it is possible to use an arrangement, wherein a projection optical system for irradiating laser light, and a light receiving optical system for receiving reflected light from a target area are disposed in one housing. The reflected light from the target area is received on a photodetector disposed in the light receiving optical system. The photodetector outputs a signal of a magnitude in accordance with a received light amount. If the signal exceeds a predetermined threshold value, it is determined that there exists an obstacle at a scanning position where the signal is detected. Further, a timing at which the signal has exceeded the threshold value is set as a light receiving timing of reflected light, and as described above, a distance to the obstacle at the scanning position is measured.

In the above arrangement, a very large emission intensity is set for laser light to be irradiated from the projection optical system to detect an obstacle at a position far from the laser radar system. In this case, however, apart of laser light may be reflected or diffracted within the housing, and may be entered into the photodetector as stray light having a variety of angle components.

As described above, if stray light is entered into the photodetector, an output signal from the photodetector may include an error component, and the precision in measuring a distance to an obstacle may be lowered. In particular, in the case where an obstacle is present at a short distance from the laser radar system, it is highly likely that an output signal from the photodetector derived from reflected light, and an output signal from the photodetector derived from stray light may overlap each other, because a time lag between an irradiation timing of laser light and a light receiving timing of reflected light is shortened. As a result, particularly in the case where an obstacle is present at a short distance from the laser radar system, the precision in measuring a distance to the obstacle may be lowered by stray light reflected or diffracted within the housing.

### SUMMARY OF THE INVENTION

A first aspect of the invention relates to a laser radar system. The laser radar system according to the first aspect includes a laser light source which emits laser light; a light scanning portion which causes the laser light to scan a target area; an optical filter which removes light of an angle component different from an angle component of reflected light of the laser light from the target area; a photodetector which receives the reflected light transmitted through the optical filter; and a light collecting element which collects the reflected light on the photodetector.

A second aspect of the invention relates to a light receiving device. The light receiving device according to the second aspect includes a photodetector; a light collecting element which collects target light on the photodetector; and an optical filter which removes light of an angle component different from the angle component of the target light.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are diagrams showing an arrangement of a laser radar system embodying the invention.

FIG. 2 is a diagram showing an arrangement of a mirror actuator in the embodiment.

FIGS. 3A through 3C are diagrams showing a process of assembling the mirror actuator in the embodiment.

FIG. 4 is a diagram showing the process of assembling the mirror actuator in the embodiment.

FIGS. 5A and 5B are diagrams showing the process of assembling the mirror actuator in the embodiment.

FIGS. 6A and 6B are diagrams showing the process of assembling the mirror actuator in the embodiment.

FIGS. 7A and 7B are diagrams showing the process of assembling the mirror actuator in the embodiment.

FIG. 8 is a diagram showing an arrangement of the laser radar system in the embodiment.

FIGS. 9A and 9B are diagrams for describing an arrangement and an operation of a servo optical system in the embodiment.

FIGS. 10A, 10B are diagrams showing an optical system of the laser radar system in the embodiment.

FIGS. 11A through 11C are diagrams showing an arrangement of a viewing control film in the embodiment.

FIG. 12 is a diagram showing a circuit configuration of the laser radar system in the embodiment.

FIGS. 13A and 13B are diagrams showing an arrangement of a viewing angle control film as a modification example.

FIGS. 14A and 14B are diagrams showing an optical system of the laser radar system as a modification example.

The drawings are provided mainly for describing the present invention, and do not limit the scope of the present invention.

### DESCRIPTION OF PREFERRED EMBODIMENTS

In the following, an embodiment of the invention is described referring to the drawings. In the embodiment, a mirror actuator 24 corresponds to a “light scanning portion” in the claims. A viewing angle control film 32 corresponds to an “optical filter” in the claims. A light receiving lens 34 corresponds to a “light collecting element” in the claims. A hole plate 23 corresponds to a “reflection plate” in the claims. The description regarding the correspondence between the claims and the embodiment is merely an example, and the claims are not limited by the description of the embodiment.

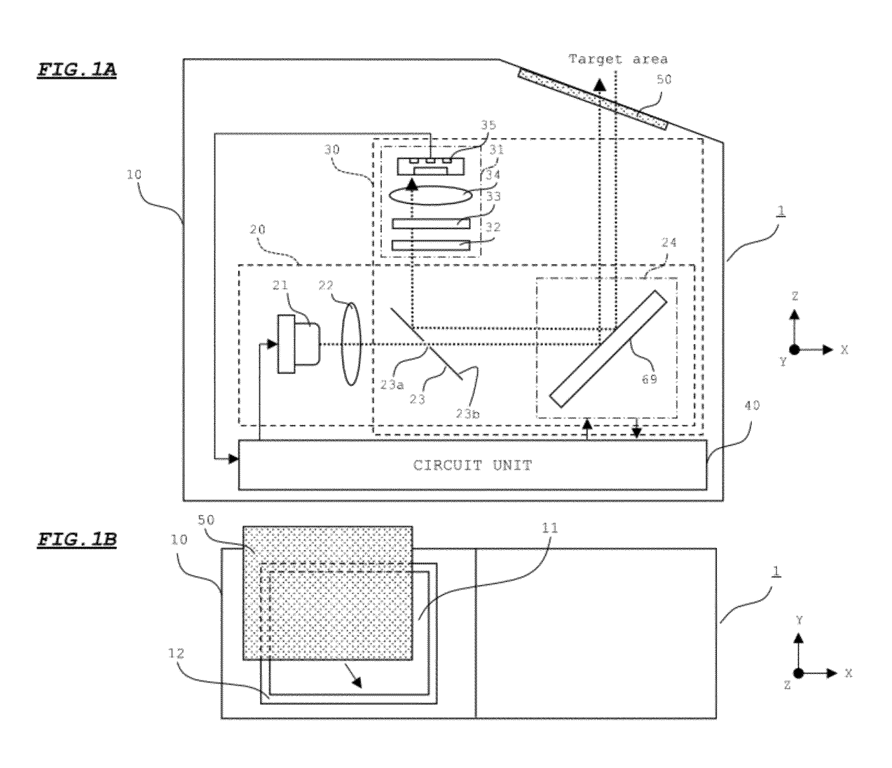

FIGS. 1A, 1B are diagrams schematically showing an arrangement of a laser radar system 1 embodying the invention. FIG. 1A is a perspective view of the interior of the laser radar system 1 when viewed from a top surface of the laser radar system 1, and FIG. 1B is a front view of the laser radar system 1 before a light projecting/receiving window 50 is mounted.

Referring to FIG. 1A, the laser radar system 1 is provided with a housing 10, a projection optical system 20, a light receiving optical system 30, a circuit unit 40, and the light projecting/receiving window 50.

The housing 10 has a cubic shape, with a part of one side thereof being inclined obliquely. The projection optical system 20, the light receiving optical system 30, and the circuit unit 40 are housed in the housing 10. As shown in FIG. 1B, an opening 11 is formed in a front surface of the housing 10, and a recess 12 for receiving the light projecting/receiving window 50 is formed in the periphery of the opening 11. The light projecting/receiving window 50 is mounted in the front surface of the housing 10 by mounting and fixing the periphery of the light projecting/receiving window 50 in the recess 12 by adhesion.

The projection optical system 20 is provided with a laser light source 21, a beam shaping lens 22, a hole plate 23, and a mirror actuator 24.

The light receiving optical system 30 is provided with a light receiving device 31. The hole plate 23 and the mirror actuator 24 are commonly used as a part of the light receiving optical system 30. The light receiving device 31 is provided with a viewing angle control film 32, a band-pass filter 33, a light receiving lens 34, and a photodetector 35.

The laser light source 21 emits laser light of a wavelength of or about 900 nm.

The beam shaping lens 22 converges emission laser light in such a manner that the emission laser light has a certain shape in a target area. For instance, the beam shaping lens 22 is designed in such a manner that the beam shape in a targeted area (which is located at a position ahead of a beam output port of a beam irradiation device by about 100 m in this embodiment) has an elliptical shape of about 2 m in the longitudinal direction and about 0.2 m in the lateral direction.

The hole plate 23 has a mirror surface 23b on the side thereof facing a mirror 69, and is formed with a hole 23a in the middle of the mirror surface 23b. As shown in FIG. 1A, the hole plate 23 is disposed with an inclination of 45 degrees in the in-plane direction of X-Z plane with respect to an optical axis of the laser light source 21. The mirror surface 23b of the hole plate 23 reflects reflected light from a target area toward the photodetector 35. The hole 23a is formed to pass through emission laser light converged by the beam shaping lens 22.

The mirror actuator 24 is provided with the mirror 69 in which emission laser light transmitted through the beam shaping lens 22 and reflected light from a target area are entered, and a mechanism for pivotally moving the mirror 69 about two axes. By pivotally moving the mirror 69, a target area is scanned with emission laser light. Further, reflected light from the target area is entered into the mirror 69 along an optical path of emission laser light toward the target area in a direction opposite to the outward direction. The reflected light entered into the mirror 69 is reflected on the mirror 69, propagates along the optical path of the emission laser light in the direction opposite to the outward direction, and is entered into the mirror surface 23b of the hole plate 23. The above-mentioned behavior of reflected light is the same at any pivot position of the mirror 69. Specifically, no matter where the pivot position of the mirror 69 may be located, reflected light from a target area propagates along the optical path of emission laser light in a direction opposite to the outward direction, and is entered into the mirror surface 23b of the hole plate 23.

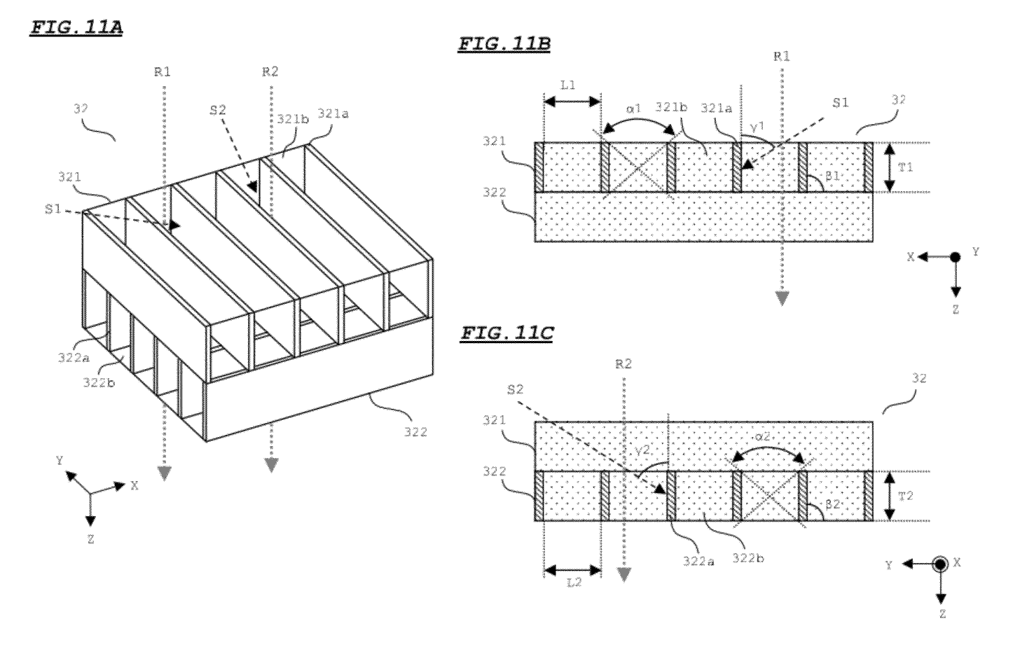

The viewing angle control film 32 has such a structure that louver layers, each of which is obtained by arranging light transmitting portions and light blocking portions in the form of stripes, are laminated. The louver layers of the viewing angle control film 32 are laminated in such a manner the light transmitting portions and the light blocking portions of each of the louver layers perpendicularly intersect each other on X-Y plane. The viewing angle control film 32 is operable to transmit only light having an incident angle component of reflected light from a target area by the louver layers, which are laminated in such a manner that the light transmitting portions and the light blocking portions perpendicularly intersect each other. The viewing angle control film 32 is disposed at such a position that a light incident surface thereof is aligned in parallel to X-Y plane. The details of the viewing angle control film 32 will be described referring to FIGS. 11A through 11C.

The band-pass filter 33 is made of a dielectric multilayer film, and transmits only light in a wavelength region of emission laser light. The band-pass filter 33 has a simplified film structure, in view of a point that reflected light is entered substantially as parallel light.

The light receiving lens 34 is a convex lens, and collects light reflected from a target area.

The photodetector 35 is constituted of an avalanche photodiode (APD) or a PIN photodiode, and outputs an electric signal of a magnitude in accordance with a received light amount to the circuit unit 40. The light receiving surface of the photodetector 35 is not divided into plural areas, but is constituted of a single light receiving surface. Further, the light receiving surface of the photodetector 35 is narrow in longitudinal and lateral directions (e.g. in the vicinity of 1 mm by 1 mm square) to suppress an influence of stray light.

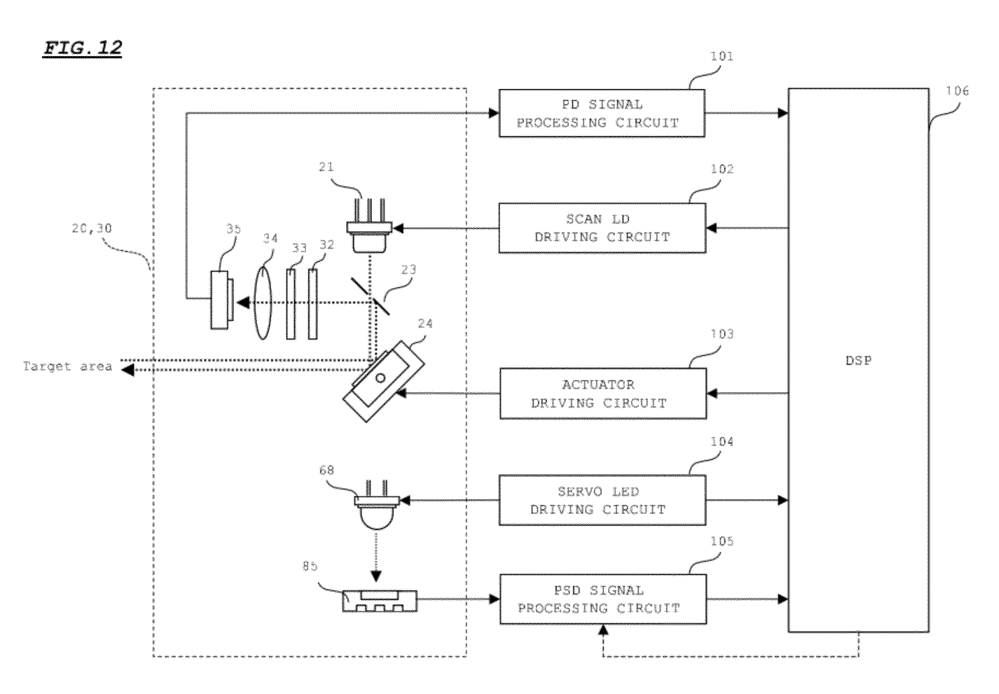

The circuit unit 40 is provided with e.g. a CPU or a memory, and controls the laser light source 21 and the mirror actuator 24. Further, the circuit unit 40 detects presence or absence of an obstacle in a target area, and measures a distance to the obstacle, based on a signal from the photodetector 35. Specifically, the laser light source 21 emits laser light at a predetermined scanning position in a target area. If a signal is outputted from the photodetector 35 in response to the laser light emission, it is detected that there exists an obstacle at the scanning position. Further, a distance to the obstacle is measured, based on a time lag between a timing at which the laser light has been emitted, and a timing at which the signal has been outputted from the photodetector 35 at the scanning position. The configuration of the circuit unit 40 will be described later referring to FIG. 12.

The light projecting/receiving window 50 is made of a transparent flat plate having a uniform thickness. The light projecting/receiving window 50 is made of a material having a high transparency. Further, an anti-reflection film (AR coat) is coated on an incident surface and an output surface of the light projecting/receiving window 50. Further, the light projecting/receiving window 50 is inclined in the in-plane direction of X-Z plane and Y-Z plane with respect to an optical axis of emission laser light by a predetermined angle to prevent a likelihood that emission laser light reflected from the light projecting/receiving window 50 may be entered into the photodetector 35 as stray light along the optical path from the hole plate 23 to the light projecting/receiving window 50 in a direction opposite to the outward direction. In the case where the mirror actuator 24 is pivotally moved, the light projecting/receiving window 50 is also inclined by such an angle as to keep emission laser light reflected from the light projecting/receiving window 50 from entering into the photodetector 35 along the optical path in a direction opposite to the outward direction.

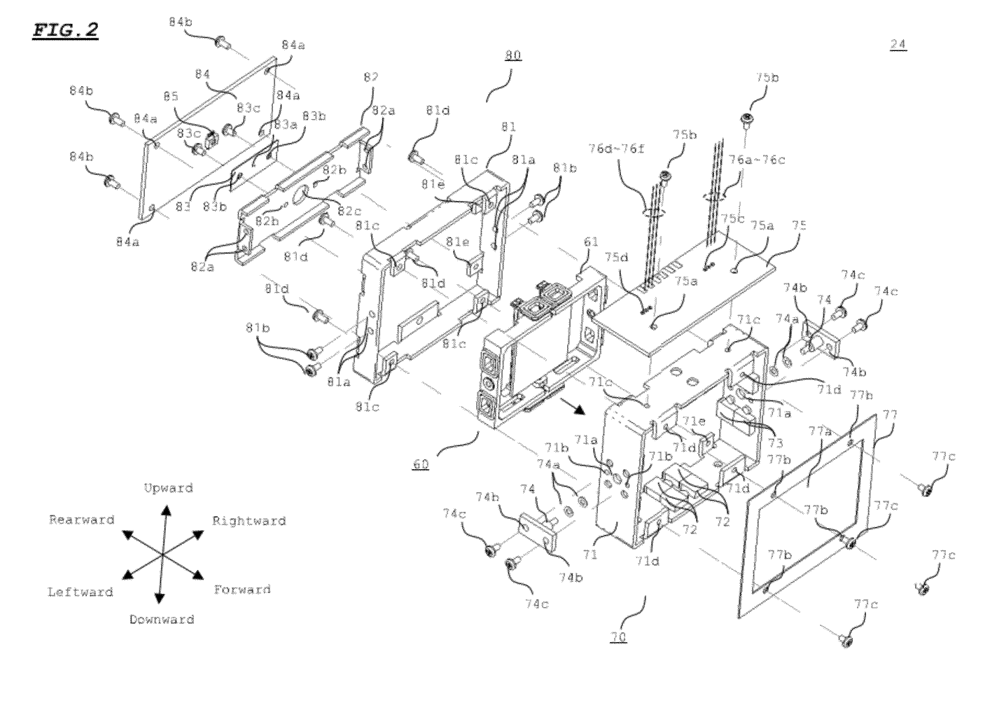

FIG. 2 is an exploded perspective view of a mirror actuator 24 embodying the invention.

The mirror actuator 24 is provided with the mirror unit 60, a magnet unit 70, and a servo unit 80.

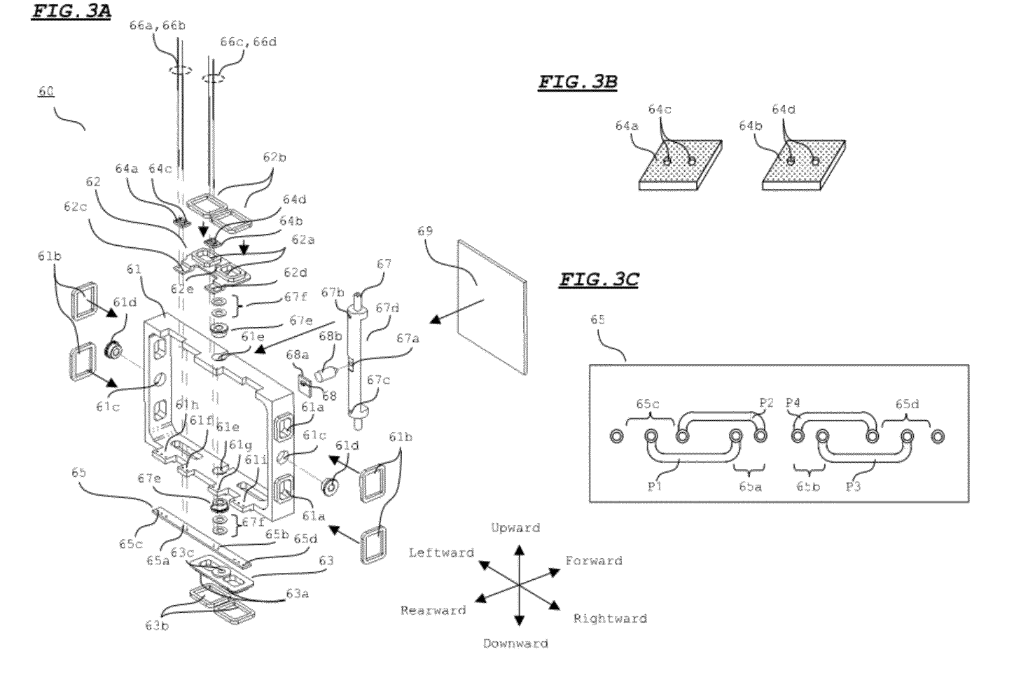

Referring to FIG. 3A, the mirror unit 60 is provided with a mirror unit frame 61, pan coil attachment plates 62, 63, suspension wire fixing substrates 64a, 64b, 65, suspension wires 66a through 66d, a support shaft 67, an LED 68, and a mirror 69.

The mirror unit frame 61 is constituted of a frame member having a rectangular shape in front view. The mirror unit frame 61 is formed with two tilt coil attachment portions 61a at each of left and right surfaces thereof. The tilt coil attachment portions 61a at each of the left and right surfaces are disposed vertically symmetrical to each other with respect to a center of each of the left and right surfaces. A tilt coil 61b is wound around and fixedly mounted on each of the four tilt coil attachment portions 61a.

The mirror unit frame 61 is further formed with laterally aligned shaft holes 61c, and vertically aligned grooves 61e. The shaft holes 61c are disposed at center positions on the left and right surfaces of the mirror unit frame 61, and the grooves 61e extend to center positions on top and bottom surfaces of the mirror unit frame 61. Bearings 61d are mounted in the shaft holes 61c from the left side and the right side.

A bottom surface of the mirror unit frame 61 has a comb-like shape; and is formed with two wire holes 61f for passing through the suspension wires 66a, 66b, two wire holes 61g for passing through the suspension wires 66c, 16d, three wire holes 61h for passing through suspension wires 76a through 76c to be described later, and three wire holes 61i for passing through suspension wires 76d through 76f to be described later. The wire holes 61h, 61i have a diameter slightly larger than the diameter of the suspension wires 76a through 76f to fixedly mount the suspension wires 76a through 76f with an inclination obliquely rearwardly. With this arrangement, it is possible to wind the suspension wires 76a through 76f with a curved shape in a direction away from the mirror 69.

The pan coil attachment plate 62 is formed with two pan coil attachment portions 62a, two wire holes 62c for passing through the suspension wires 66a, 66b, two wire holes 62d for passing through the suspension wires 66c, 66d, and a shaft hole 62e for passing through the support shaft 67. The wire holes 62c are vertically and linearly aligned with respect to the wire holes 61f, and the wire holes 62d are vertically and linearly aligned with respect to the wire holes 61g. Two pan coils 62b are wound around and fixedly mounted on the two pan coil attachment portions 62a. Further, the pan coil attachment plate 63 is formed with two pan coil attachment portions 63a, and a shaft hole 63c for passing through the support shaft 67. Two pan coils 63b are wound around and fixedly mounted on the pan coil attachment portions 63a.

The suspension wire fixing substrates 64a, 64b are respectively formed with two terminal holes 64c for passing through the suspension wires 66a, 66b, and two terminal holes 64d for passing through the suspension wires 66c, 66d (see FIG. 3B). As will be described later, the pan coils 62b, 63b, and a conductive wire for supplying a current to the LED 68 are electrically connected to the suspension wires 66a through 66d at the positions of the terminal holes 64c, 64d by soldering or a like process. The suspension wire fixing substrates 64a, 64b are fixedly mounted on the pan coil attachment plate 62 by adhesion in such a manner that the two terminal holes 64c, 64d and the wire holes 62c, 62d are aligned with each other.

The suspension wire fixing substrate 65 is formed with two terminal holes 65a for passing through the suspension wires 66a, 66b, two terminal holes 65b for passing through the suspension wires 66c, 66d, three terminal holes 65c for passing through the suspension wires 76a through 76c, and three terminal holes 65d for passing through the suspension wires 76d through 76f (see FIG. 2). The three terminal holes 65c, 65d have a diameter slightly larger than the diameter of the suspension wires 76a through 76f to wind the suspension wires 76a through 76f with a curved shape, as well as the wire holes 61h, 61i.

Referring to FIG. 3C, the suspension wire fixing substrate 65 is formed with circuit patterns P1, P2 for electrically connecting between the two terminal holes 65a and two of the three terminal holes 65c. The suspension wire fixing substrate 65 is further formed with circuit patterns P3, P4 for electrically connecting between the two terminal holes 65b and two of the three terminal holes 65d. By soldering between these terminal holes, and the suspension wires 66a through 66d and the suspension wires 76a, 76b, 76d, 76e passing through the respective corresponding terminal holes, the suspension wires 66a through 66d, and the suspension wires 76a, 76b, 76d, 76e are electrically connected to each other via the above circuit patterns. As will be described later, the left and right tilt coils 61b, and the suspension wires 76c, 76f are electrically connected to each other by soldering or a like process at the positions of the remaining one of the three terminal holes 65c and the remaining one of the three terminal holes 65d.

Referring back to FIG. 3A, the suspension wire fixing substrate 65 is fixedly mounted on the mirror unit frame 61 by adhesion in such a manner that the terminal holes 65a and the wire holes 61f, the terminal holes 65b and the wire holes 61g, the terminal holes 65c and the wire holes 61h, and the terminal holes 65d and the wire holes 61i are aligned with each other.

The suspension wires 66a through 66d are made of phosphor bronze, beryllium copper or a like material, and have excellent electrical conductivity and spring property. The suspension wires 66a through 66d have a circular shape in cross section. The suspension wires 66a through 66d have the same shape and property as each other, are used to supply a current to the pan coils 62b, 63b and the LED 68, and to exert stable load in pivotally moving the mirror 69 in Pan direction.

The support shaft 67 is formed with a hole 67a for receiving an LED substrate fixing arm 68b, holes 67b, 67c for passing through conductive wires for electrically connecting between the pan coils 63b and the LED 68, and a step portion 67d for receiving the mirror 69. Further, the inside of the support shaft 67 is formed hollow to pass through the conductive wires for electrically connecting between the pan coils 63b and the LED 68. As will be described later, the support shaft 67 is used as a pivot shaft for pivotally moving the mirror 69 in Pan direction.

The LED 68 is of a diffusive type (a wide-directivity type), and is capable of diffusing light in a wide range. As will be described later, diffused light from the LED 68 is used to detect a scanning position of scanning laser light within a target area. The LED 68 is mounted on an LED substrate 68a. The LED substrate 68a is adhesively mounted on the LED substrate fixing arm 68b, and thereafter, is mounted in the hole 67a of the support shaft 67.

In assembling the mirror unit 60, after the mirror 69 is received in the support shaft 67, bearings 67e and poly-slider washers 67f are mounted on shaft portions at both ends of the support shaft 67. Then, in this state, the two bearings 67e are received in the grooves 61e formed in the mirror unit frame 61. Further, the support shaft 67 is vertically passed through the shaft hole 62e in the pan coil attachment plate 62 and the shaft hole 63c in the pan coil attachment plate 63, and is fixedly mounted thereat by adhesion.

Thereafter, the suspension wires 66a, 66b are passed through the terminal holes 65a in the suspension wire fixing substrate 65 via the two terminal holes 64c in the suspension wire fixing substrate 64a, the two wire holes 62c, and the two wire holes 61f. Likewise, the suspension wires 66c, 66d are passed through the terminal holes 65b in the suspension wire fixing substrate 65 via the two terminal holes 64d in the suspension wire fixing substrate 64b, the two wire holes 62d, and the two wire holes 61g. The suspension wires 66a, 66b are soldered to the suspension wire fixing substrates 64a, 65, and the suspension wires 66c, 66d are soldered to the suspension wire fixing substrates 64b, 65, with the conductive wires for supplying a current to the pan coils 62b, 63b and the LED 68.

With the above arrangement, as shown in FIG. 2, the assembling of the mirror unit 60 is completed. In this state, the mirror 69 is made pivotally movable about an axis of the support shaft 67 in Pan direction. The suspension wire fixing substrates 64a, 64b are pivotally moved in Pan direction, as the mirror 69 is pivotally moved in Pan direction. The assembled mirror unit 60 is housed in an opening of a magnet unit frame 71.

Referring back to FIG. 2, the magnet unit 70 is provided with the magnet unit frame 71, eight pan magnets 72, eight tilt magnets 73, two support shafts 74, a suspension wire fixing substrate 75, the suspension wires 76a through 76f, and a protection cover 77.

The magnet unit frame 71 is constituted of a frame member having a rectangular shape in front view. The magnet unit frame 71 is formed with a shaft hole 71a for passing through the corresponding support shaft 74, and screw holes 71b for fixedly mounting the support shaft 74 in the middle on each of left and right surfaces thereof. Two screw holes 71c are formed in a top surface of the magnet unit frame 71 for fixedly mounting the suspension wire fixing substrate 75. Further, four flange portions projecting toward the inside of the magnet unit frame 71 are formed at front ends of top and bottom inner surfaces of the magnet unit frame 71. A screw hole 71d for fixedly mounting the protection cover 77 is formed in each of the four flange portions. Likewise, four flange portions projecting toward the inside of the magnet unit frame 71 are formed at rear ends of the top and bottom inner surfaces of the magnet unit frame 71. A screw hole 71e for fixedly mounting a servo unit frame 81 is formed in each of the four flange portions.

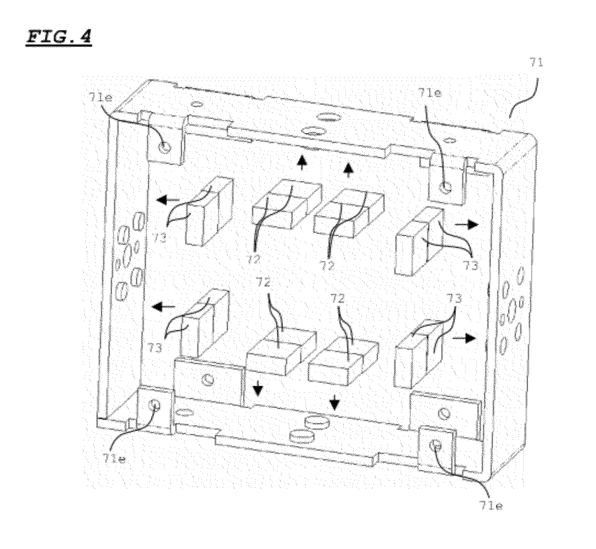

FIG. 4 is a perspective view of the magnet unit frame 71 when viewed from a rear side. Referring to FIG. 4, the eight pan magnets 72 are attached to the top and bottom inner surfaces of the magnet unit frame 71. Further, the eight tilt magnets 73 are attached to left and right inner surfaces of the magnet unit frame 71.

Referring back to FIG. 2, each of the two support shafts 74 is formed with two screw holes 74b. The two support shafts 74 are received in the bearings 61d of the mirror unit frame 61 via the shaft holes 71a formed in the magnet unit frame 71 in a state that poly-slider washers 74a are mounted. In this state, two screws 74c are screwed into the two screw holes 71b in the magnet unit frame 71 via the two screw holes 74b. With this arrangement, the two support shafts 74 are fixedly mounted on the magnet unit frame 71. As will be described later, the support shafts 74 are used as rotating shafts for pivotally moving the mirror 69 in Tilt direction.

The suspension wire fixing substrate 75 is formed with two screw holes 75a, and three terminal holes 75c, 75d for passing through the suspension wires 76a through 76f. The three terminal holes 75c, 75d have a diameter slightly larger than the diameter of the suspension wires 76a through 76f for winding the suspension wires 76a through 76f with a curved shape. The suspension wire fixing substrate 75 is formed with a circuit pattern for supplying a signal to the terminal holes 75c, 75d.

The suspension wires 76a through 76f are made of e.g. phosphor bronze, beryllium copper or a like material, and have excellent electrical conductivity and spring property. The suspension wires 76a through 76f have a circular shape in cross section. The suspension wires 76a through 76f have the same shape and property as each other, and are used to supply a current to the tilt coils 61b, the pan coils 62b, 63b and the LED 68, and to exert stable load in pivotally moving the mirror 69 in Tilt direction.

In assembling the magnet unit 70, the suspension wire fixing substrate 75 is mounted on the top surface of the magnet unit frame 71. In this state, two screws 75b are screwed into the two screw holes 71c via the two screw holes 75a. With this arrangement, the suspension wire fixing substrate 75 is fixedly mounted on the magnet unit frame 71.

Thereafter, the suspension wires 76a through 76c are passed through the terminal holes 65c (see FIG. 3A) in the suspension wire fixing substrate 65 via the three terminal holes 75c in the suspension wire fixing substrate 75, and the three wire holes 61h in the mirror unit frame 61. Likewise, the suspension wires 76d through 76f are passed through the three terminal holes 65d (see FIG. 3A) in the suspension wire fixing substrate 65 via the three terminal holes 75d in the suspension wire fixing substrate 75, and the three wire holes 61i in the mirror unit frame 61.

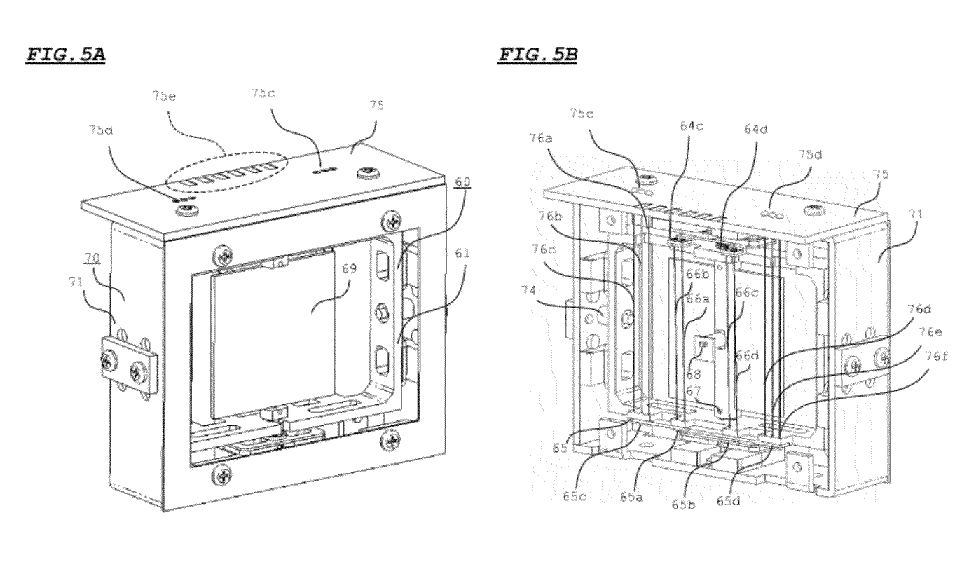

Thereafter, the suspension wires 76a through 76f are soldered to the suspension wire fixing substrates 65, 75 with the conductive wires for supplying a current to the pan coils 62b, 63b and the LED 68. The suspension wires 76a through 76f are wound with a curved shape in a direction away from the mirror 69. Specifically, upper ends of the suspension wires 76a through 76f are fixedly received in the terminal holes 75c, 75d in such a manner as to be inclined rearwardly, as the suspension wires 76a through 76f are away from the terminal holes 75c, 75d. Likewise, lower ends of the suspension wires 76a through 76f are fixedly received in the wire holes 61h, 61i and the terminal holes 65b, 65c in such a manner as to be inclined rearwardly, as the suspension wires 76a through 76f are away from the wire holes 61h, 61i and the terminal holes 65b, 65c. With this arrangement, a structural body shown in FIGS. 5A, 5B is completed. In this state, the mirror unit frame 61 is made pivotally movable in Tilt direction about axes of the support shafts 74. The suspension wire fixing substrate 65 is pivotally moved in Tilt direction, as the mirror unit frame 61 is pivotally moved in Tilt direction.

FIGS. 5A, 5B are perspective views of the structural body in a state that the mirror unit 60 is mounted on the magnet unit 70. FIG. 5A is a perspective view of the structural body when viewed from a front side in FIG. 2, and FIG. 5B is a perspective view of the structural body when viewed from a rear side in FIG. 2.

Referring to FIG. 5B, ends of the suspension wire 66a are connected to the inner one of the two terminal holes 64c, and to the inner one of the two terminal holes 65a. Likewise, ends of the suspension wire 66c are connected to the inner one of the two terminal holes 64d, and to the inner one of the two terminal holes 65b.

Ends of the suspension wire 66b are connected to the outer one of the two terminal holes 64c, and to the outer one of the two terminal holes 65a. Likewise, ends of the suspension wire 66d are connected to the outer one of the two terminal holes 64d, and to the outer one of the two terminal holes 65b.

Ends of the suspension wire 76a are connected to the inner one of the three terminal holes 75c, and to the inner one of the three terminal holes 65c. Likewise, ends of the suspension wire 76d are connected to the inner one of the three terminal holes 75d, and to the inner one of the three terminal holes 65d.

Ends of the suspension wire 76b are connected to the middle one of the three terminal holes 75c, and to the middle one of the three terminal holes 65c. Likewise, ends of the suspension wire 76e are connected to the middle one of the three terminal holes 75d, and to the middle one of the three terminal holes 65d.

Ends of the suspension wire 76c are connected to the outer one of the three terminal holes 75c, and to the outer one of the three terminal holes 65c. Likewise, ends of the suspension wire 76f are connected to the outer one of the three terminal holes 75d, and to the outer one of the three terminal holes 65d.

In FIG. 5A, the reference sign 75e indicates terminals. A drive signal for driving the mirror 69 in Pan direction and in Tilt direction, and a drive signal for turning the LED 68 on are supplied via the terminals 75e. Each of the terminals 75e is connected to the corresponding one of the terminal holes 75c, 75d via the circuit pattern formed on the suspension wire fixing substrate 75.

Referring back to FIG. 2, the servo unit 80 is provided with the servo unit frame 81, a pinhole attachment bracket 82, a pinhole plate 83, a PSD substrate 84, and a PSD 85.

The servo unit frame 81 is constituted of a frame member having a rectangular shape in front view. The servo unit frame 81 is formed with two screw holes 81a for fixedly mounting the pinhole attachment bracket 82 in each of left and right surfaces thereof. Further, four flange portions projecting toward the inside of the servo unit frame 81 are formed at front ends of top and bottom inner surfaces of the servo unit frame 81. A screw hole 81c is formed in each of the four flange portions. Likewise, four flange portions projecting toward the inside of the servo unit frame 81 are formed at rear ends of the left and right inner surfaces of the servo unit frame 81. A screw hole 81e is formed in each of the four flange portions.

The pinhole attachment bracket 82 is formed with two screw holes 82a in each of left and right surfaces thereof. The pinhole attachment bracket 82 is formed, on a back surface thereof, with two screw holes 82b for fixedly mounting the pinhole plate 83, and an opening 82c for guiding servo light emitted from the LED 68 to the PSD 85 via a pinhole 83a.

The pinhole plate 83 is formed with the pinhole 83a and two screw holes 83b. The pinhole 83a is adapted to pass through a part of diffused light emitted from the LED 68.

The PSD substrate 84 is formed with four screw holes 84a for fixedly mounting the PSD substrate 84 on the servo unit frame 81. The PSD 85 is mounted on the PSD substrate 84. The PSD 85 outputs a signal depending on a light receiving position of servo light.

In assembling the servo unit 80, the pinhole plate 83 is mounted on the back surface of the pinhole attachment bracket 82. In this state, two screws 83c are screwed into the two screw holes 82b via the two screw holes 83b. With this arrangement, the pinhole plate 83 is fixedly mounted on the pinhole attachment bracket 82.

Next, the pinhole attachment bracket 82 is housed in the servo unit frame 81. In this state, the four screw holes 81a and the four screw holes 82a are aligned with each other, and four screws 81b are screwed into the screw holes 81a and the screw holes 82a from the left side and the right side. With this arrangement, the pinhole attachment bracket 82 is fixedly mounted on the servo unit frame 81.

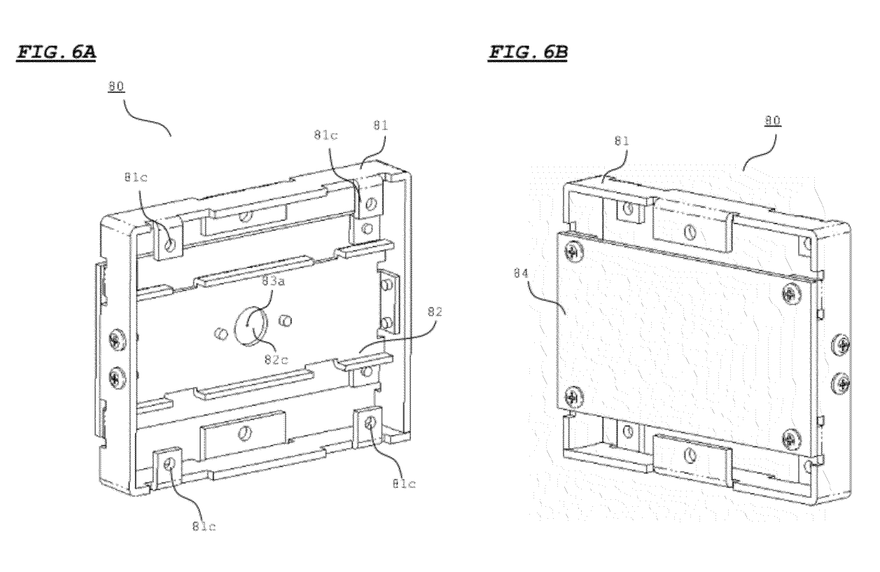

Further, the PSD substrate 84 is mounted on a back portion of the servo unit frame 81. In this state, four screws 84b are screwed into the four screw holes 81e via the four screw holes 84a. With this arrangement, the PSD substrate 84 is fixedly mounted on the servo unit frame 81. In this way, the servo unit 80 shown in FIGS. 6A, 6B is completed. FIG. 6A is a perspective view of the assembled servo unit 80 when viewed from a front side, and FIG. 6B is a perspective view of the assembled servo unit 80 when viewed from a rear side.

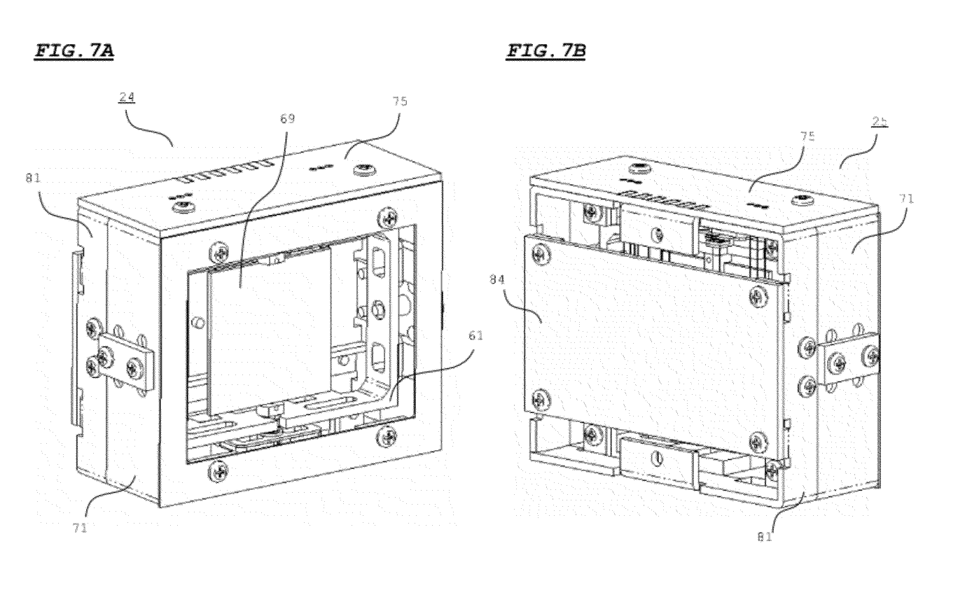

After the servo unit 80 is assembled as described above, the servo unit 80 is mounted on the back portion of the structural body shown in FIGS. 5A, 5B. In this state, the four screws 81d are screwed into the four screw holes 71e in the magnet unit frame 71 from a rear side via four screw holes 81c in the servo unit frame 81. With this arrangement, the servo unit 80 is fixedly mounted on the structural body shown in FIGS. 5A, 5B. Thus, as shown in FIGS. 7A, 7B, the assembling of the mirror actuator 24 is completed. FIG. 7A is a perspective view of the mirror actuator 24 when viewed from a front side, and FIG. 7B is a perspective view of the mirror actuator 24 when viewed from a rear side.

In the assembled state shown in FIGS. 7A, 7B, the eight pan magnets 72 (see FIG. 4) have the dispositions and the polarities thereof adjusted in such a manner that a force for pivotally moving the pan coil attachment plates 62, 63 about the axis of the support shaft 67 is generated in the pan coil attachment plates 62, 63 by applying a current to the pan coils 62b, 63b (see FIG. 3A). With this arrangement, when a current is applied to the pan coils 62b, 63b, the support shaft 67 is pivotally moved with the pan coil attachment plates 62, 63 by an electromagnetic driving force generated in the pan coils 62b, 63b, whereby the mirror 69 is pivotally moved about the axis of the support shaft 67. The pivot direction of the mirror 69 about the axis of the support shaft 67 is called as Pan direction. The mirror 69 is returned to the position before pivotal movement by the spring property of the suspension wires 66a through 66d in response to stopping application of a current to the pan coils 62b, 63b.

In the assembled state shown in FIGS. 7A, 7B, the eight tilt magnets 73 (see FIG. 4) have the dispositions and the polarities thereof adjusted in such a manner that a force for pivotally moving the mirror unit frame 61 about the axes of the support shafts 74 is generated in the mirror unit frame 61 by applying a current to the tilt coils 61b (see FIG. 3A). With this arrangement, when a current is applied to the tilt coils 61b, the mirror unit frame 61 is pivotally moved about the axes of the support shafts 74 by an electromagnetic driving force generated in the tilt coils 61b, whereby the mirror 69 is pivotally moved with the mirror unit frame 61. The pivot direction of the mirror 69 about the axes of the support shafts 74 is called as Tilt direction. The mirror unit frame 61 is returned to the position before pivotal movement by the spring property of the suspension wires 76a through 76f in response to stopping application of a current to the tilt coils 61b.

It is possible to drive the mirror 69 of a large size with a high response by configuring the mirror actuator 24 as described above. Accordingly, it is possible to receive reflected light from a target area by the mirror 69 of a large size.

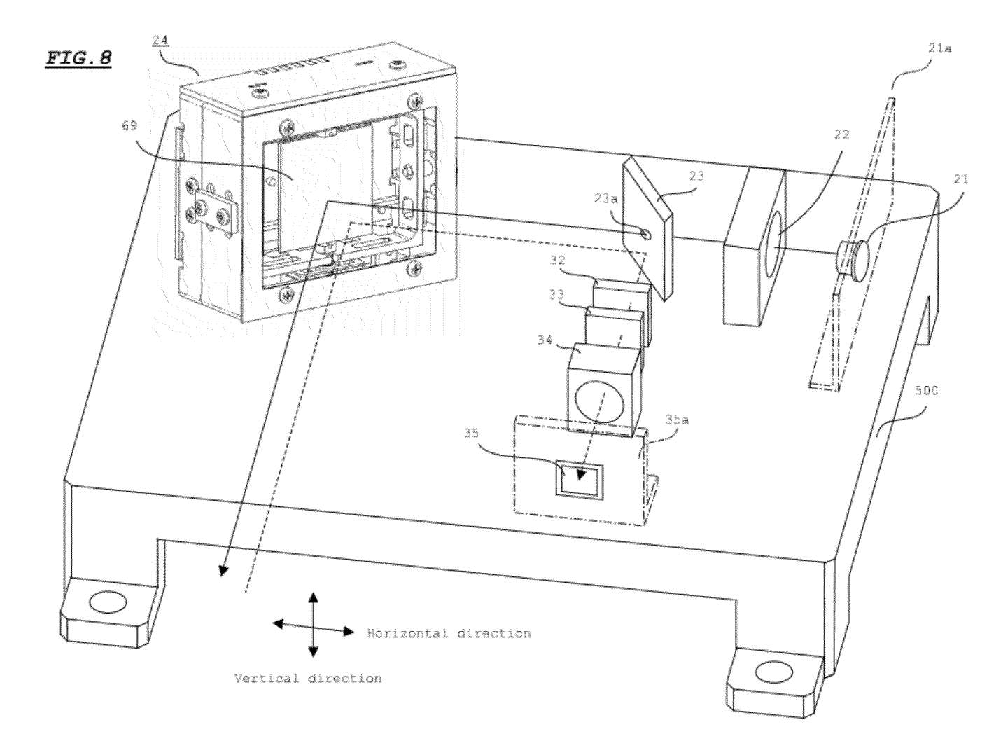

FIG. 8 is a diagram showing an arrangement of an optical system in a state that the mirror actuator 24 is mounted.

Referring to FIG. 8, the reference sign 500 indicates a base member for supporting an optical system.

The laser light source 21, the beam shaping lens 22, the hole plate 23, the mirror actuator 24, the viewing angle control film 32, the band-pass filter 33, the light receiving lens 34, and the photodetector 35 are disposed on a top surface of the base member 500. The laser light source 21 is mounted on a circuit board 21a for a laser light source, which is disposed on the top surface of the base member 500. Further, the photodetector 35 is mounted on a circuit board 35a for the photodetector 35, which is disposed on the top surface of the base member 500.

Laser light emitted from the laser light source 21 is converged in a horizontal direction and in a vertical direction by the beam shaping lens 22, and is formed into a certain shape in a target area. After passing through the hole 23a formed in the hole plate 23, the emission laser light transmitted through the beam shaping lens 22 is entered into the mirror 69 of the mirror actuator 24, and is reflected on the mirror 69 toward the target area. By driving the mirror 69 by the mirror actuator 24, the target area is scanned with the emission laser light.

The mirror actuator 24 is disposed at such a position that scanning laser light from the beam shaping lens 22 is entered into the mirror surface of the mirror 69 at an incident angle of 45 degrees with respect to the horizontal direction, when the mirror 69 is set to a neutral position. The “neutral position” is a position of the mirror 69, in the case where the mirror surface of the mirror 69 is aligned in parallel to the vertical direction, and scanning laser light is entered into the mirror surface at an incident angle of 45 degrees with respect to the horizontal direction.

There are disposed, in addition to the circuit boards 21a and 35a, circuit boards (not shown) for supplying a drive signal to the tilt coils 61b and the pan coils 62b, 63b for the mirror actuator 24 at a position behind the mirror actuator 24 on the top surface of the base member 500. These circuit boards are included in the circuit unit 40 shown in FIG. 1A.

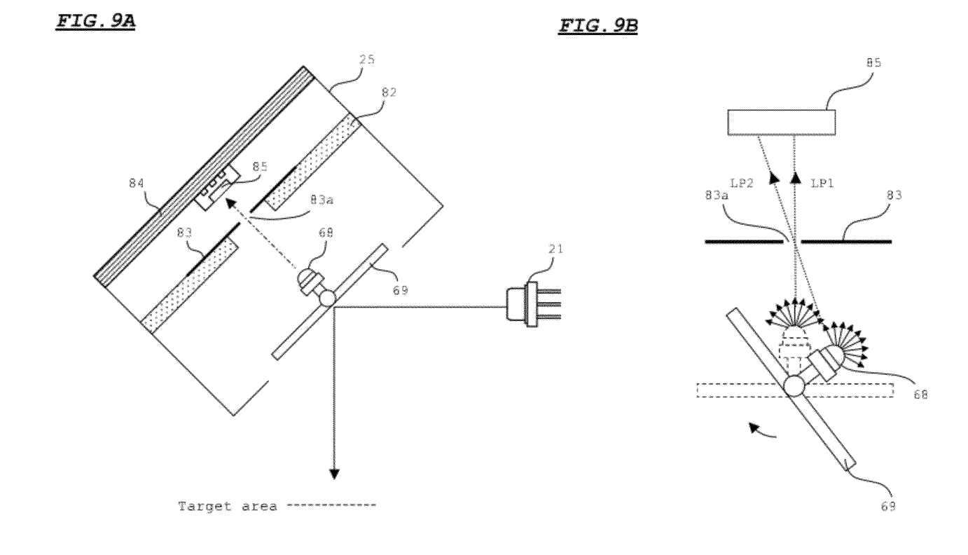

FIG. 9A is a diagram for describing a servo optical system for detecting the position of the mirror 69. FIG. 9A is a schematic perspective view of the optical system shown in FIG. 8 when viewed from the side of the top surface of the base member 500. In FIG. 9A, only a partially cross-sectional view of the mirror actuator 24, and the laser light source 21 are shown.

As described above, the mirror actuator 24 is provided with the LED 68, the pinhole attachment bracket 82, the pinhole plate 83, the PSD substrate 84, and the PSD 85.

The LED 68, the PSD 85, and the pinhole 83a are disposed at such positions that the LED 68 faces the pinhole 83a in the pinhole plate 83 and the center of the PSD 85, when the mirror 69 of the mirror actuator 24 is set to the neutral position. Specifically, when the mirror 69 is set to the neutral position, the pinhole plate 83 and the PSD 85 are disposed at such positions that servo light emitted from the LED 68 and passing through the pinhole 83a is entered into the center of the PSD 85 in a direction perpendicular to the PSD 85. Further, the pinhole plate 83 is disposed at a position closer to the PSD 85 with respect to the intermediate position between the LED 68 and the PSD 85.

In this example, a part of servo light diffusively emitted from the LED 68 passes through the pinhole 83a, and is received on the PSD 85. Servo light entered into an area of the pinhole plate 83 other than the pinhole 83a is blocked by the pinhole plate 83. The PSD 85 outputs a current signal depending on the light receiving position of servo light.

For instance, as shown in FIG. 9B, in the case where the mirror 69 is pivotally moved in the arrow direction from the neutral position indicated by the broken line, the optical path of light passing through the pinhole 63a, of diffused light (servo light) from the LED 68, is displaced from LP1 to LP2. As a result of the displacement, the irradiation position of servo light on the PSD 85 changes, and a position detection signal to be outputted from the PSD 85 changes. In this case, the emission position of servo light from the LED 68, and the incident position of servo light on the light receiving surface of the PSD 85 have a one-to-one correspondence. Accordingly, it is possible to detect the position of the mirror 69 by the incident position of servo light to be detected by the PSD 85 to thereby detect the scanning position of scanning laser light in a target area.

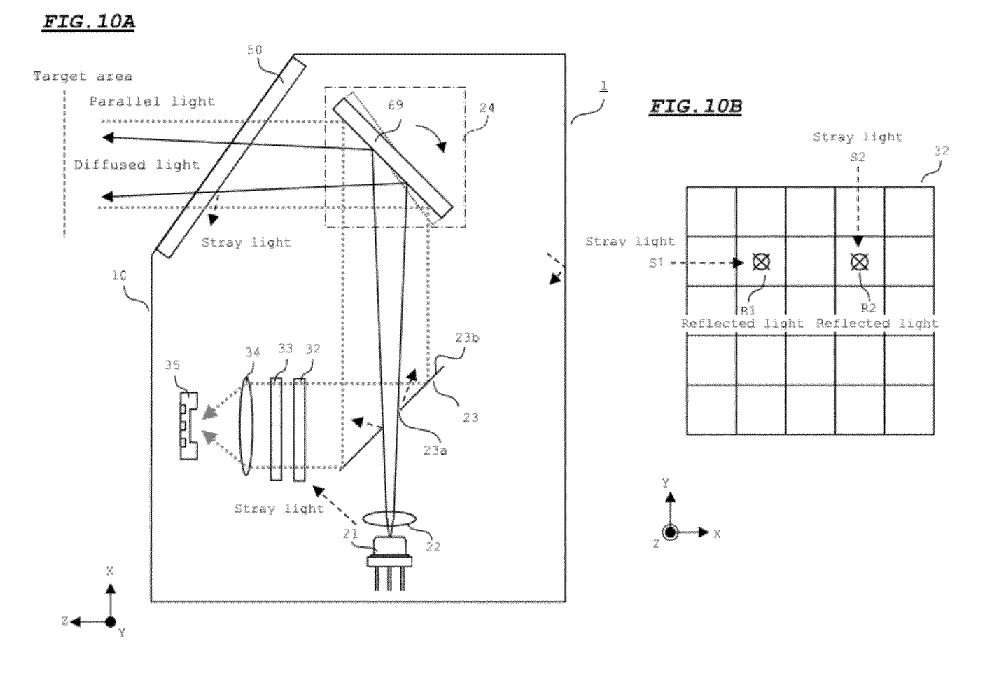

FIG. 10A is a partially plan view of the interior of the laser radar system 1 when viewed from the top surface thereof. In FIG. 10A, emission laser light is indicated by the solid-line arrow, and reflected light from a target area is indicated by the dotted-line arrow. Further, stray light within the housing 10 is schematically indicated by the broken-line arrow. FIG. 10B is a top plan view of the viewing angle control film 32 on X-Y plane when viewed from the negative Z-axis direction. In FIG. 10B, reflected light from a target area and propagating in the plus Z-axis direction is indicated by the cross mark overlapping the circle, and stray light entered with an inclination in the in-plane direction of X-Y plane is indicated by the broken-line arrow.

Referring to FIG. 10A, after transmitted through the beam shaping lens 22, laser light emitted from the laser light source 21 passes through the hole 23a formed in the hole plate 23. The emission laser light that has passed through the hole 23a in the hole plate 23 is reflected on the mirror 69, and then is emitted toward a target area from the interior of the housing 10.

The emission laser light to be emitted from the interior of the housing 10 is diffused light. Specifically, emission laser light is emitted from the interior of the housing 10 as diffused light. In contrast, reflected light reflected from a target area and entered into the housing 10 is substantially parallel light, because the light is reflected on an obstacle in the target area, which is present far (e.g. at a distance of several ten meters) from the laser radar system 1. Therefore, the reflected light is entered into the mirror 69 as substantially parallel light.

In FIG. 10A, to simplify the description, it is shown that the incident area of emission laser light on the mirror 69 is about one-half the incident area of reflected light. Actually, however, the incident area of reflected light is several times as large as the incident area of emission laser light. Accordingly, the incident area of reflected light on the mirror surface 23b of the hole plate 23 is significantly large, as compared with the passing area of emission laser light on the mirror surface 23b of the hole plate 23.

As described above, reflected light is entered into the mirror surface 23b of the hole plate 23 as substantially parallel light on an area larger than the passing area of emission laser light. With the above arrangement, a most part of reflected light is reflected on the mirror surface 23b of the hole plate 23. Reflected light from a target area, which has been reflected on the mirror surface 23b of the hole plate 23, is entered into the viewing angle control film 32 as substantially parallel light with respect to the normal to the light incident surface (X-Y plane) of the viewing angle control film 32. The reflected light from the target area, which has been entered into the viewing angle control film 32, is transmitted through the light transmitting portions of the louver layers of the viewing angle control film 32. Thereafter, the reflected light from the target area is transmitted through the band-pass filter 33, is collected by the light receiving lens 34, and is entered into the photodetector 35. In this way, it is possible to detect reflected light from a target area.

Further, in the case where the mirror 69 is pivotally moved in the arrow direction, reflected light from a target area is reflected on the mirror 69 in the same direction as the direction before pivotal movement of the mirror 69. Specifically, reflected light from a target area is reflected on the mirror 69 in a direction in parallel to the optical axis of the laser light source 21, no matter where the pivot position of the mirror 69 may be located. Thus, reflected light from a target area is entered into the viewing angle control film 32 as substantially parallel light along the same optical path, no matter where the pivot position of the mirror 69 may be located.

Further, as shown in FIG. 10A, the laser light source 21 and the photodetector 35 are disposed in the housing 10. Accordingly, a part of laser light diffracted in e.g. the emission port of the laser light source 21 or in the hole 23a in the hole plate 23 may be directly or indirectly reflected within the housing 10, and may be entered into the photodetector 35 as stray light. Further, a part of laser light reflected from the light projecting/receiving window 50, which is inclined in the in-plane direction of X-Z plane and Y-Z plane, may be directly or indirectly reflected within the housing 10, and may be entered into the photodetector 35 as stray light. It is impossible to remove these stray light by the band-pass filter 33, because these stray light has the same wavelength region as the wavelength region of laser light. As described above, these stray light has a variety of angle components by diffraction and reflection on the optical elements or wall portions within the housing 10.

Referring to FIG. 10B, the reference sign S1 indicates stray light which is inclined in X-axis direction with respect to the normal to the light incident surface (X-Y plane) of the viewing angle control film 32, and the reference sign S2 indicates stray light which is inclined in Y-axis direction with respect to the normal to the light incident surface (X-Y plane) of the viewing angle control film 32.

Further, as described above, reflected light R1, R2 from a target area is entered into the viewing angle control film 32 as substantially parallel light with respect to the normal to the light incident surface of the viewing angle control film 32, no matter where the pivot position of the mirror 69 may be located.

As described above, reflected light from a target area is constantly entered as substantially parallel light with respect to the normal to the light incident surface (X-Y plane) of the viewing angle control film 32, and a most part of stray light is entered with an inclination in the in-plane direction of the light incident surface (X-Y plane) of the viewing angle control film 32. Accordingly, it is possible to suppress an influence of stray light which may enter into the photodetector 35 by removing light which is inclined at a predetermined angle or more in the in-plane direction of the light incident surface (X-Y plane) of the viewing angle control film 32.

FIGS. 11A through 11C are diagrams for describing a light blocking function of the viewing angle control film 32 in the embodiment.

FIG. 11A is a perspective view schematically showing the viewing angle control film 32. Further, FIG. 11B is a cross-sectional view of the viewing angle control film 32 on X-Z plane, and FIG. 11C is a cross-sectional view of the viewing angle control film 32 on Y-Z plane.

The viewing angle control film 32 has louver layers 321, 322.

The louver layer 321 is configured in such a manner that light blocking portions 321a and light transmitting portions 321b are alternately formed along X-axis direction. The light blocking portions 321a and the light transmitting portions 321b extend in parallel to each other with respect to Y-Z plane. Further, each of the light blocking portions 321a has a strip form of a small size in X-axis direction, and each of the light transmitting portions 321b has a strip form of a large size in X-axis direction. The size of the light blocking portion 321a in X-axis direction is fixed, and the size of the light transmitting portion 321b in X-axis direction is also fixed.

The light blocking portions 321a are made of a light blocking material having a property of absorbing light. The light blocking portions 321a block the stray light S1 which is inclined in X-axis direction at a predetermined angle or more with respect to the normal to the light incident surface (X-Y plane) of the louver layer 321.

The light transmitting portions 321b are made of a light transmitting material having a property of transmitting light. The light transmitting portions 321b transmit the reflected light R1 which is entered as substantially parallel light with respect to the normal to the light incident surface (X-Y plane) of the louver layer 321.

Referring to FIG. 11B, an angle β1 defined by the light blocking portion 321a and the surface of the louver layer 321 is set to 90 degrees. The light blocking portions 321a are formed at an interval L1 in X-axis direction. Further, each of the light blocking portions 321a has a thickness T1 in the laminated direction of the louver layers 321, 322. With this arrangement, an angle (a viewing angle) at which light is allowed to transmit through the louver layer 321 is restricted to α1.

The viewing angle α1 can be decreased by decreasing the interval L1 of the light blocking portions 321a and by increasing the thickness T1 of the light blocking portion 321a. Conversely, the viewing angle α1 can be increased by increasing the interval L1 of the light blocking portions 321a and by decreasing the thickness T1 of the light blocking portion 321a. Further, it is possible to adjust the angle at which the reflected light R1 is allowed to enter by adjusting the angle β1 defined by the light blocking portion 321a and the surface of the louver layer 322.

In this embodiment, the reflected light R1 is entered as substantially parallel light with respect to the normal to the light incident surface (X-Y plane) of the louver layer 321. In view of the above, the interval L1 of the light blocking portions 321a is set to a very small value, and the thickness T1 of the light blocking portion 321a is set to a very large value so that the viewing angle α1 is approximated to zero degree. With this arrangement, it is possible to block the stray light S1 having a larger incident angle γ1 than the viewing angle α1 in X-axis direction with respect to the normal to the light incident surface (X-Y plane) of the louver layer 321 by the light blocking portions 321a of the louver layer 321.

The light blocking portions 322a are made of a light blocking material having a property of absorbing light. The light blocking portions 322a block the stray light S2 which is inclined in Y-axis direction at a predetermined angle or more with respect to the normal to the light incident surface (X-Y plane) of the louver layer 322.

Referring back to FIG. 11A, the louver layer 322 is configured in such a manner that light blocking portions 322a and light transmitting portions 322b are alternately formed along Y-axis direction. The light blocking portions 322a and the light transmitting portions 322b extend in parallel to each other with respect to X-Z plane. Further, each of the light blocking portions 322a has a strip form of a small size in Y-axis direction, and each of the light transmitting portions 322b has a strip form of a large size in Y-axis direction. The size of the light blocking portion 322a in Y-axis direction is fixed, and the size of the light transmitting portion 322b in Y-axis direction is also fixed.

The light transmitting portions 322b are made of a light transmitting material having a property of transmitting light. The light transmitting portions 322b transmit the reflected light R2 which is entered as substantially parallel light with respect to the normal to the light incident surface (X-Y plane) of the louver layer 322.

Referring to FIG. 11C, an angle β2 defined by the light blocking portion 322a and the surface of the louver layer 322 is set to 90 degrees. The light blocking portions 322a are formed with an interval L2. Further, each of the light blocking portions 322a has a thickness T2 in the laminated direction of the louver layers 321, 322.

In this embodiment, the reflected light R2 is entered as substantially parallel light with respect to the normal to the light incident surface (X-Y plane) of the louver layer 322. In view of the above, the interval L2 of the light blocking portions 322a is set to a very small value, and the thickness T2 of the light blocking portion 322a is set to a very large value in the same manner as the louver layer 321 so that a viewing angle α2 is approximated to zero degree. With this arrangement, it is possible to block the stray light S2 having a larger incident angle γ2 than the viewing angle α2 in Y-axis direction with respect to the normal to the light incident surface (X-Y plane) of the louver layer 322 by the light blocking portions 322a of the louver layer 322.

Referring back to FIG. 11A, the louver layer 321 and the louver layer 322 are configured in such a manner that the light blocking portions 321a, 322a perpendicularly intersect each other. With this arrangement, the viewing angle control film 32 is operable to block the stray light S1, S2 which are inclined at a predetermined angle or more in the in-plane direction of X-Y plane, and to transmit the reflected light R1, R2 which are entered in a direction substantially perpendicular to X-Y plane.

In this embodiment, the viewing angle control film 32 is disposed on an optical path in which reflected light from a target area is formed into parallel light. Alternatively, the viewing angle control film 32 may be disposed on an optical path along which light is converged, for instance, at a position posterior to the light receiving lens 34. In the modification, however, the incident angle of reflected light with respect to the light incident surface of the viewing angle control film 32 varies in accordance with an incident position of reflected light. Accordingly, it is necessary to adjust the inclination angles β1, β2 of the light blocking portions 321a, 322a of the louver layers 321, 322 to keep reflected light from being blocked by the louver layers 321, 322 in accordance with an incident position of reflected light.

On the other hand, disposing the viewing angle control film 32 on an optical path in which reflected light is formed into substantially parallel light, as described in the embodiment, is advantageous in effectively removing stray light having an angle component different from the angle component of reflected light from a target area, by the louver layers 321, 322 having a simplified arrangement as described above.

FIG. 12 is a diagram showing a circuit configuration of the laser radar system 1. In FIG. 12, to simplify the description, primary elements of the projection optical system 20 and the light receiving optical system 30 are also shown. As shown in FIG. 12, the laser radar system 1 is provided with a PD signal processing circuit 101, a scan LD driving circuit 102, an actuator driving circuit 103, a servo LED driving circuit 104, a PSD signal processing circuit 105, and a DSP 106. These circuits are included in the circuit unit 40 shown in FIG. 1A.

The PD signal processing circuit 101 amplifies a voltage signal from the photodetector 35 in accordance with a received light amount, converts the amplified signal into a digital signal, and supplies the digital signal to the DSP 106.

The scan LD driving circuit 102 supplies a drive signal to the laser light source 21, based on a signal from the DSP 106. Specifically, a pulse drive signal (a current signal) is supplied to the laser light source 21 at a timing at which laser light is irradiated onto a target area.

The PSD signal processing circuit 105 outputs, to the DSP 106, a position detection signal obtained based on an output signal from the PSD 85. The servo LED driving circuit 104 supplies a drive signal to the LED 68, based on a signal from the DSP 106. The actuator driving circuit 103 drives the mirror actuator 24, based on a signal from the DSP 106. Specifically, a drive signal for causing laser light to scan along a predetermined trajectory in a target area is supplied to the mirror actuator 24.

The DSP 106 detects a scanning position of laser light in a target area, based on a position detection signal inputted from the PSD signal processing circuit 105; and performs e.g. driving control of the mirror actuator 24 and driving control of the laser light source 21. Further, the DSP 106 judges whether an obstacle is present at an irradiation position of laser light in the target area, based on a voltage signal to be inputted from the PD signal processing circuit 101; and at the same time, measures a distance to the obstacle, based on a time lag between an irradiation timing of laser light to be outputted from the laser light source 21, and a light receiving timing of reflected light from the target area, which is received by the photodetector 35.

As described above, in the embodiment, it is possible to efficiently remove stray light of an angle component different from the angle component of reflected light from a target area by disposing the viewing angle control film 32 on an optical path in which reflected light from the target area is formed into substantially parallel light. With this arrangement, even in the case where a projection optical system and a light receiving optical system are disposed in one housing, it is possible to properly receive reflected light from a target area.

Further, in the embodiment, it is possible to suppress an influence of stray light at an irradiation timing of laser light. Accordingly, it is possible to precisely measure a distance to an obstacle, even if the obstacle is present near the laser radar system.

The embodiment of the invention has been described as above. The invention is not limited to the foregoing embodiment, and the embodiment of the invention may be modified in various ways other than the above.

For instance, in the embodiment, reflected light from a target area is allowed to enter at an incident angle of substantially zero degree with respect to the light incident surface of the viewing angle control film 32. Alternatively, it is possible to allow reflected light to enter into the viewing angle control film 32 in a state that the reflected light is inclined by a predetermined angle θ with respect to the light incident surface of the viewing angle control film 32. In the modification, it is possible to adjust the incident angle of reflected light to be entered into the viewing angle control film 32 by adjusting the angle β1 defined by the light blocking portion 321a and the surface of the louver layer 321, or the angle β2 defined by the light blocking portion 322a and the surface of the louver layer 322.

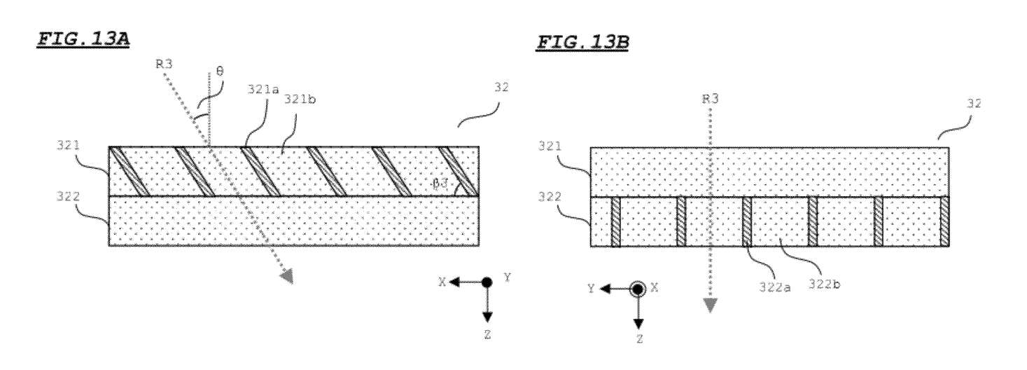

FIGS. 13A, 13B are diagrams schematically showing a light blocking function of a viewing angle control film 32, in the case where reflected light is entered into the viewing angle control film 32 at an incident angle θ in the in-plane direction of X-Z plane. FIG. 13A is a cross-sectional view of the viewing angle control film 32 on X-Z plane, and FIG. 13B is a cross-sectional view of the viewing angle control film 32 on Y-Z plane.

Referring to FIG. 13A, a louver layer 321 is configured in such a manner that light blocking portions 321a and light transmitting portions 321b are alternately formed in the same manner as the embodiment. An angle β3 defined by the light blocking portion 321a and the surface of the louver layer 321 is inclined from Z-axis direction toward X-axis direction so that the angle β3 is made substantially equal to the incident angle θ of reflected light R3.

Referring to FIG. 13B, a louver layer 322 is configured in such a manner that light blocking portions 322a and light transmitting portions 322b are alternately formed in the same manner as the embodiment. Further, the angle defined by the light blocking portion 322a and the surface of the louver layer 322 is set to 90 degrees.

Further, the louver layer 321 and the louver layer 322 are laminated in such a manner that the light blocking portions 321a, 322a perpendicularly intersect each other in the same manner as the embodiment.

With the above arrangement, the viewing angle control film 32 is operable to transmit the reflected light R3 from a target area, which is entered at the incident angle θ with respect to the light incident surface (X-Y plane) of the viewing angle control film 32, and to block light having an inclination of a predetermined angle or more in the in-plane direction of the light incident surface (X-Y plane) of the viewing angle control film 32.

As described above, in the case where the reflected light is entered into the light incident surface (X-Y plane) of the viewing angle control film 32 with a certain inclination, it is also possible to remove stray light having an angle component different from the angle component of reflected light from a target area by forming the light blocking portions 321a of the louver layer 321 with an inclination in the same manner as the embodiment.

Further, in the embodiment, reflected light is entered into the viewing angle control film 32 as substantially parallel light. Alternatively, reflected light may be slightly diffused or slightly converged with respect to parallel light. In the modification, as compared with the embodiment, light may be slightly attenuated, and the removal efficiency of stray light may be lowered to some extent. However, it is possible to remove stray light of an angle component different from the angle component of reflected light by adjusting the viewing angle of the viewing angle control film in the same manner as the embodiment.

Further, in the embodiment, a light blocking box may be additionally provided in such a manner as to surround the photodetector 35.

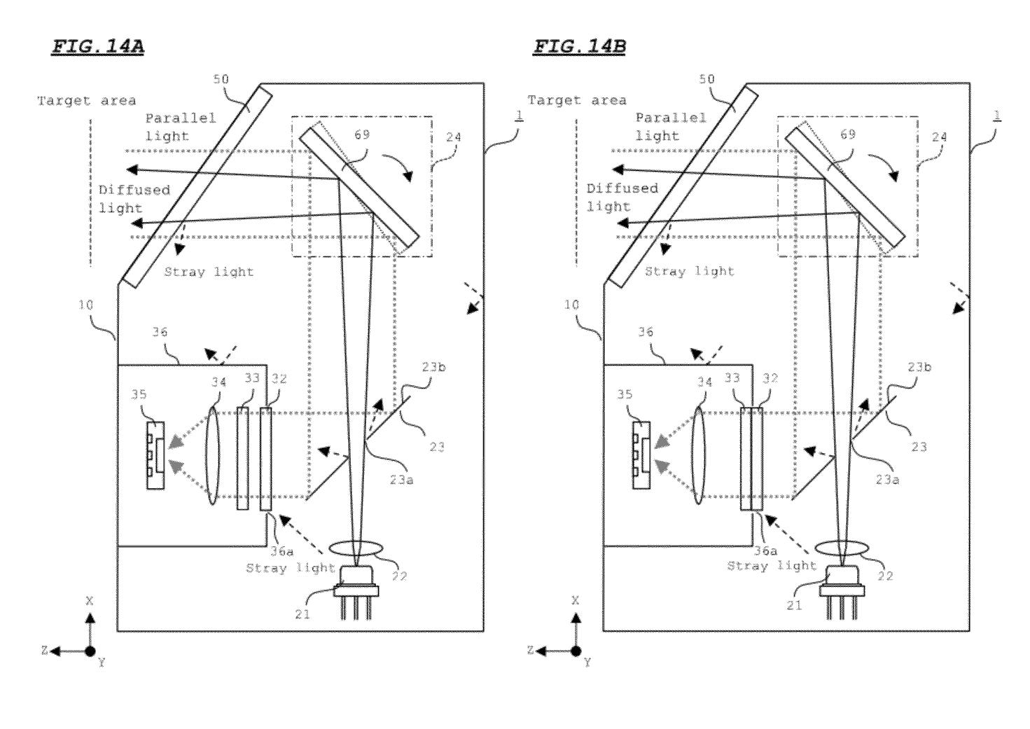

FIG. 14A is a partially plan view of the interior of the laser radar system 1 when viewed from a top surface of the laser radar system 1 in the case where a light blocking box 36 is disposed. In FIG. 14A, the elements substantially identical or equivalent to those in the embodiment are indicated with the same reference signs.

An outer surface of the light blocking box 36 is made of a material having a light blocking property. The light blocking box 36 is disposed at such a position as to surround the band-pass filter 33, the light receiving lens 34, and the photodetector 35. An opening 36a is formed in the middle on one surface of the light blocking box 36. The viewing angle control film 32 is held in the opening 36a. The outer surface of the light blocking box 36 blocks incidence of light that is entered into a position other than the position where the viewing angle control film 32 is held in the opening 36a.

With the above arrangement, it is possible to remove stray light of an angle component different from the angle component of reflected light from a target area in the same manner as the embodiment. Further, in this modification example, since the light blocking box 36 is disposed at such a position as to surround the photodetector 35, it is possible to remove stray light passing through a position other than the position corresponding to the viewing angle control film 32 by the light blocking box 36. Accordingly, in the modification example is more advantageous in removing stray light that may be entered into the photodetector 35, as compared with above embodiment.

Further, in the above modification example and in the embodiment, the viewing angle control film 32 and the band-pass filter 33 are formed as individual members. Alternatively, for instance, as shown in FIG. 14B, the viewing angle control film 32 and the band-pass filter 33 may be integrally formed. The modification is advantageous in reducing the number of parts, and in simplifying and miniaturizing the arrangement of the laser radar system.

Further, in the embodiment, there has been described an arrangement example of the laser radar system, wherein the optical paths of the projection optical system 20 and the light receiving optical system 30 are made coincident with each other. Alternatively, it is possible to apply, to the invention, an arrangement example of the laser radar system, wherein a projection optical system and a light receiving optical system are individually disposed, and the optical paths of the projection optical system and the light receiving optical system do not coincide with each other. In the modification, the incident angle of reflected light to be entered into the light receiving optical system may vary, as laser light is caused to scan a target area. However, it is possible to apply the above arrangement to the invention by adjusting the viewing angle of the viewing angle control film to a wide angle.

Furthermore, in the embodiment, there has been descried an arrangement example, wherein a laser radar system is loaded in e.g. a vehicle. The inventive light receiving device is applicable to any device, as far as the device is configured in such a manner as to receive reflected light from a target area projected with light by e.g. a photodetector, such as a motion sensor.

The embodiment of the invention may be changed or modified in various ways as necessary, as far as such changes and modifications do not depart from the scope of the claims of the invention hereinafter defined.

What is claimed is:

1. A laser radar system, comprising:
a laser light source which emits laser light;
a light scanning portion which causes the laser light to scan a target area;
an optical filter which removes light of an angle component different from an angle component of reflected light of the laser light from the target area;
a photodetector which receives the reflected light transmitted through the optical filter; and
a light collecting element which collects the reflected light on the photodetector.

2. The laser radar system according to claim 1, wherein
the optical filter is disposed on an optical path of the reflected light before incidence into the light collecting element.

3. The laser radar system according to claim 1, wherein
the optical filter includes
a first louver layer configured in such a manner that a first light blocking portion which blocks light of an angle component different from the angle component of the reflected light, and a first light transmitting portion which transmits the reflected light are alternately formed, and
a second louver layer configured in such a manner that a second light blocking portion which blocks light of an angle component different from the angle component of the reflected light, and a second light transmitting portion which transmits the reflected light are alternately formed, and
the first light blocking portion and the second light blocking portion perpendicularly intersect each other.

4. The laser radar system according to claim 1, further comprising:
a reflection plate including a reflection surface on a side opposite to the side of the laser light source, the reflection plate being formed with a hole for passing through the laser light emitted from the laser light source, and the reflection plate being disposed between the laser light source and the light scanning portion with an inclination with respect to an optical axis of the laser light, wherein
the reflected light from the target area is entered into the optical filter after reflected on the reflection surface.

5. The laser radar system according to claim 1, further comprising:
a band-pass filter which removes light of a wavelength component different from the wavelength component of the reflected light, wherein
the band-pass filter is disposed on an optical path of the reflected light before incidence into the light collecting element.

6. A light receiving device for receiving target light having a predetermined angle component, comprising:
a photodetector;
a light collecting element which collects the target light on the photodetector; and
an optical filter which removes light of an angle component different from the angle component of the target light.

7. The light receiving device according to claim 6, wherein
the optical filter is disposed on the optical path of the target light before incidence into the light collecting element.

8. The light receiving device according to claim 6, wherein
the optical filter includes
a first louver layer configured in such a manner that a first light blocking portion which blocks light of an angle component different from the angle component of the target light, and a first light transmitting portion which transmits the target light are alternately formed, and
a second louver layer configured in such a manner that a second light blocking portion which blocks light of an angle component different from the angle component of the target light, and a second light transmitting portion which transmits the target light are alternately formed, and
the first light blocking portion and the second light blocking portion perpendicularly intersect each other.

9. The light receiving device according to claim 6, further comprising:
a band-pass filter which removes light of a wavelength component different from the wavelength component of the target light, wherein
the band-pass filter is disposed on the optical path of the target light before incidence into the light collecting element.
